(19) United States
(12) Patent Application Publication
(10) Pub. No.: US 2025/0016764 A1
(43) Pub. Date: Jan. 9, 2025

(54) VOICE COMMUNICATION SYSTEM

(71) Applicant: Frequentis AG, Wien (AT)

(72) Inventor: Hannes Prokop, Wien (AT)

(21) Appl. No.: 18/762,948

(22) Filed: Jul. 3, 2024

(30) Foreign Application Priority Data
Jul. 4, 2023 (EP) 23183331.0

(51) Int. Cl. H04W 72/121; H04W 4/10; H04W 4/16

(52) U.S. Cl. CPC H04W 72/121; H04W 4/10; H04W 4/16

(57) ABSTRACT

A voice communication system contains a plurality of transmitting/receiving systems connected to a first controller workstation. The first controller workstation has a loudspeaker for outputting voice radio messages to a user, a microphone for receiving voice radio messages emitted by the user and an input unit. A receive transmission mode or a transmit/receive transmission mode can be selected for the individual radio station groups by the user via the input unit. An encrypted communication mode or an unencrypted communication mode can be selected for the individual radio station groups by the user via the input unit.

### CROSS-REFERENCE TO RELATED APPLICATION

This application claims the priority, under 35 U.S.C. § 119, of European Patent Application EP 23183331.0, filed Jul. 4, 2023; the prior application is herewith incorporated by reference in its entirety.

### FIELD AND BACKGROUND OF THE INVENTION

The invention relates to a voice communication system containing a plurality of transmitting/receiving systems connected to a first controller workstation as claimed in the independent claim.

Voice communication systems are known from the prior art that are used in military air traffic control or command and control applications. In such well-known systems, each controller or operator is equipped with a controller workstation that has an input unit and a push-to-talk button. The controllers can access various shared radio stations to communicate with civil and military aircraft.

Radio stations that are located in different geographical locations but can be reached via the same radio channel are logically grouped to allow controllers to cover wide geographical areas in radio communications. Each controller usually uses several of these radio station groups in parallel. The controller can use each of the radio station groups either only for reception (RX) or for reception and transmission (TX). This RX/TX setting of a respective radio station group is called key-in mode.

Depending on the type of aircraft and the current situation, radio communication can be encrypted (Secure/COMSEC ON) or unencrypted (Plain/COMSEC OFF). If a group consists of radio stations that support encrypted communication, the controller can switch between Plain/COMSEC OFF and Secure/COMSEC ON communication from the controller workstation.

While the key-in mode chosen by one controller does not affect the communication of another controller communicating with the same radio stations or radio station groups, the COMSEC setting must be consistent for all radio stations in a group and for all controllers using that radio station group. Therefore, the COMSEC setting is transmitted from the voice communication system to all controller workstations that are currently using a respective radio channel.

Controllers, especially in military applications, often use several radio station groups in rapid succession, transmitting secret information via individual radio station groups in encrypted mode, while information that is not to be kept secure is transmitted via other radio station groups in unencrypted mode. For this purpose, several work steps must be carried out by the controller:

First, the controller selects the desired radio station group for transmission via the input unit of the controller workstation and changes the key-in mode of this radio station group to TX. After that, the controller can start the actual radio transmission by pressing the push-to-talk button. If a different radio station group is to be used for the next transmission, the controller must set the key-in mode of the first radio station group back to RX, set the next radio station group to TX and then use the push-to-talk button to send the next radio message.

In situations where the controller frequently has to switch between radio station groups in secure or plain mode, the large number of work steps required exposes him to an additional workload, which increases the likelihood of a potentially incorrect selection of the radio station group with which to communicate. In the event that several radio station groups are to be used simultaneously in secure or plain mode, the previously described workflow must be repeated for each individual radio station group.

Since the workflow involves changing the key-in mode of the radio station groups, which must be communicated by the voice communication system to all radio stations of the respective radio station group, the change of the key-in mode also creates a noticeable delay in the region of a few seconds before the controller can start transmitting.

### SUMMARY OF THE INVENTION

The object of the invention is therefore to provide a voice communication system that overcomes the previously mentioned disadvantages and in particular enables an immediate start of transmission and reduces the sequence of work steps for switching between groups, so that the workload of the controllers is reduced, which significantly reduces the potential for human error in the form of, for example, the selection of a wrong radio station group.

The invention achieves this object in a voice communication system containing a plurality of transmitting/receiving systems for transmitting and/or receiving radio signals to a radio station group and/or from a plurality of radio station groups. The radio station groups each contain a plurality of geographically distributed radio stations and wherein voice radio messages can each be sent to the individual radio station groups on different radio channels and/or received by the individual radio station groups,
wherein the transmitting/receiving systems are connected to a first common controller workstation,
wherein the first controller workstation contains a loudspeaker for outputting voice radio messages to a user, a microphone for receiving voice radio messages emitted by the user and an input unit,
wherein a receive transmission mode or a transmit/receive transmission mode can be selected by the user via the input unit for the individual radio station groups, and
wherein an encrypted communication mode or an unencrypted communication mode can be selected by the user via the input unit for the individual radio station groups, and
wherein the first controller workstation contains a push-to-talk unit, and
wherein the first controller workstation contains a control and processing unit which is connected between the transmitting/receiving systems and the air traffic controller workstation, wherein the control and processing unit contains a buffer memory and wherein the radio channels of the individual radio station groups and the respective selected transmission mode are stored in the buffer memory, with the characterizing features of the independent claim.

According to the invention, it is intended that the push-to-talk unit contains at least two configurable push-to-talk buttons, wherein at least one radio station group and one communication mode can be assigned to each of the push-to-talk buttons by the user via the input unit.

Owing to this design of a voice communication system according to the invention, it is advantageously possible that a controller can start radio messages to one or more radio station groups in the desired encrypted or unencrypted communication mode only by pressing one of the at least two push-to-talk buttons. Since the selected transmission mode and the selected communication mode are stored for the respective push-to-talk button for the respective radio station groups that are to be contacted, the workflow for the controller is significantly simplified and thus the susceptibility to errors is significantly reduced.

In particular, the workload of the user or the controller is reduced by the fact that radio transmissions of both confidential, encrypted, and non-confidential, unencrypted voice messages are possible without additional input on the input unit, but simply by pressing one of the configurable push-to-talk buttons.

In order to make a voice communication system according to the invention usable for several controllers, it may be provided that the transmitting/receiving systems are connected to at least one further common controller workstation.

In order to be able to ensure, in the case of a voice communication system according to the invention that is used by several controllers, that controllers at the other controller workstations can also send radio messages to one or more radio station groups in the desired encrypted or unencrypted communication mode in a simple manner and without a complex sequence of tasks, it may be provided that the at least one further controller workstation contains a further loudspeaker for the output of voice radio messages to a user, a further microphone for receiving voice radio messages emitted by the user, a further input unit, and a further control and processing unit with a further buffer memory,
wherein the user can select a receive transmission mode or a transmit/receive transmission mode for the individual radio station groups via the further input unit, and
wherein an encrypted communication mode or an unencrypted communication mode can be selected for the individual radio station groups by the user via the further input unit,
wherein the radio channels of the individual radio station groups and the respective selected transmission mode are stored in the further buffer memory, and
wherein the further controller workstation contains a further push-to-talk unit, wherein the further push-to-talk unit contains at least two configurable push-to-talk buttons, wherein at least one radio station group and one communication mode can be assigned to each of the push-to-talk buttons by the user via the further input unit.

In order to ensure, when assigning several radio station groups to the individual push-to-talk buttons, that by pressing the respective push-to-talk button, communication is only possible with radio station groups that are in the same communication mode and are therefore allowed or can receive all confidential information to be encrypted or all information that is not to be encrypted, it may be provided that the control and processing unit is designed, when several radio station groups are assigned by the user to a respective push-to-talk button, to check whether the same communication mode is assigned to the individual radio station groups.

Since a communication mode can be newly selected for the individual radio station groups, when a new, further controller workstation is connected, it may be provided that the control and processing unit is designed to determine the current communication mode of the radio station group concerned when a further controller workstation is connected and when a respective radio station group is used for the first time at the further controller workstation, wherein in particular it is provided that the control and processing unit is configured to display the current communication mode of the radio station group in question to the user at the further controller workstation.

This design of a voice communication system according to the invention advantageously ensures that the newly added user at the further workstation always knows the current communication mode of all radio station groups, so that any unnecessary changes of the communication mode are avoided.

Since the communication mode selected for the individual radio station groups can also be actively changed by a user or controller, for example if problems in the transmission quality are detected, or if the selected communication mode changes due to a failure, for example of the encryption device of a radio station, and such inadmissible combinations of radio station groups in the encrypted communication mode as well as in the unencrypted communication mode can result on the same push-to-talk button, it may be provided that the control and processing unit is configured to check, after the assignment of several radio station groups to a respective push-to-talk button, at specified intervals, in particular on an ongoing basis, whether the individual radio station groups are still assigned the same communication mode and, in the event of the detection of a change in the communication mode of a radio station group, to terminate the assignment of the radio station group to the respective push-to-talk button.

In order to inform a user that, in the case of an existing assignment of several radio station groups to the same push-to-talk button or in the case of a newly selected assignment of several radio station groups to the same push-to-talk button, inadmissible combinations of encrypted and unencrypted communication modes have resulted or are being created, it may be provided that the control and processing unit is designed to output an in particular optical and/or acoustic warning to the user at a controller workstation,
in the event that when several radio station groups are assigned by a user to a respective push-to-talk button, one of the radio station groups is not assigned the same communication mode; and/or
in the event that the assignment of a radio station group to the push-to-talk button has ended; and/or
in the event of a change in the communication mode of one of the radio station groups (CG) by the user of a further controller workstation, i.e. in the event that the communication mode of one of the radio station groups used at the controller workstation in question is changed by the user of another, different controller workstation.

A controller workstation of a voice communication system according to the invention can be configured to be particularly compact, clear and simple for the user to operate if the loudspeaker and/or the microphone and/or the push-to-talk unit are arranged in or on a headset or are enclosed by it.

In order to avoid a delay in the transmission of radio messages particularly efficiently, it can be provided that the input unit can be used by the user to assign at least one radio station group for which the transmit/receive transmission mode is selected to each of the push-to-talk buttons. This advantageously ensures that the at least one radio station group is already in transmit/receive mode, so that the user can start their transmission immediately.

Further advantages and embodiments of the invention result from the description and the accompanying drawings.

Other features which are considered as characteristic for the invention are set forth in the appended claims.

Although the invention is illustrated and described herein as embodied in a voice communication system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration schematically showing an exemplary embodiment of a controller workstation of a voice communication system according to the invention; and

FIG. 2 is an illustration of an example of a group of radio stations that receive and transmit radio signals from and to the transmitting/receiving equipment of the voice communication system that are connected to two controller workstations.

### DETAILED DESCRIPTION OF THE INVENTION

In the following exemplary embodiment, the operational use of a voice communication system VCS according to the invention is explained in more detail, wherein the system has controller workstations CWP1, CWP2 that are each equipped with a push-to-talk unit 7 with two configurable push-to-talk buttons.

### Starting Situation

Two military air traffic controllers are carrying out a mission together and require reliable radio communication with their own military aircraft, with military aircraft from neighboring countries and with civilian aircraft that are in close proximity to their own forces or military aircraft.

In order to ensure increased reliability, the two air traffic controllers or controllers are located in spatially distant buildings and use a voice communication system VCS according to the invention both for communication with each other by telephone connection and for communication with the aircraft by voice radio. Each controller has a controller workstation CWP1, CWP2.

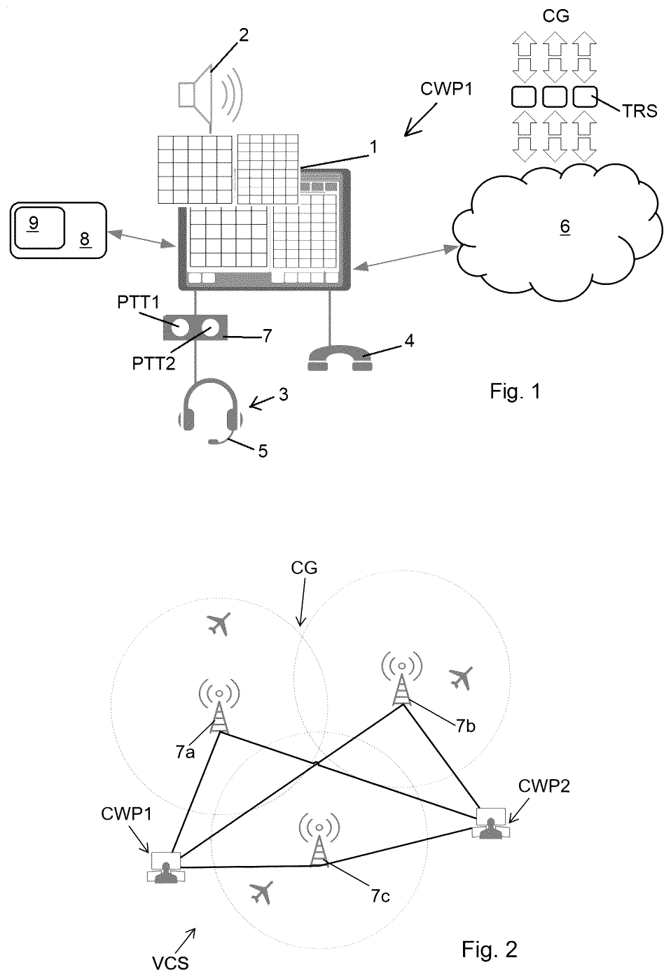

A first such controller workstation CWP1 is schematically shown in FIG. 1 and has an input unit 1, for example a touchscreen. In the exemplary embodiment in FIG. 1, several audio devices, namely a headset 3, a telephone receiver 4 and a loudspeaker 2, are connected to the controller workstation CWP1 (see FIG. 1). The two types of communication, radio and telephony, are provided by the voice communication system VCS here and can be carried out by means of the same audio devices. Radio messages are output to the user, i.e. the controller, via the loudspeaker 2 and radio messages emitted by the controller are received via a microphone 5.

The voice communication system VCS contains several transmitting/receiving systems TRS for transmitting or receiving radio signals to or from a plurality of radio station groups CG. One such radio station group CG contains a plurality of geographically distributed radio stations 7a, 7b, 7c, which can send or receive radio messages on the same radio channel. The transmitting/receiving systems TRS are connected to the controller workstations CWP1, CWP2. This connection is implemented by means of a network 6, to which all controller workstations and transmitting/receiving systems TRS of the voice communication system VCS are connected. The network enables the transmission of digital voice data, control commands and status information.

Using the input unit 1, each controller can enter or select a receive transmission mode RX or a transmit/receive transmission mode TX for the individual radio station groups CG. Furthermore, each controller can select an encrypted communication mode S or an unencrypted communication mode P for the individual radio station groups CG by means of the input unit 1.

In order to store these settings selected for the individual radio station groups CG, the first controller workstation CWP1 contains a control and processing unit 8 with a buffer memory 9 in which not only the selected transmission mode for a respective radio station group CG can be stored, but also the radio channel via which the respective radio station group CG communicates.

The first controller workstation CWP1 also has a push-to-talk unit 7, which in the exemplary embodiment is housed in the connection cable between the headset 3 and the controller workstation CWP 1. In the exemplary embodiment, the push-to-talk unit 7 has two configurable push-to-talk buttons. Each of the push-to-talk buttons PTT1, PTT2 can be assigned one or more radio station groups CG and a communication mode by the controller by means of the input unit 1. The information about which radio station groups CG with which communication mode have been assigned to a respective push-to-talk button PTT1, PTT2 by the controller can advantageously also be stored in the buffer memory.

In the exemplary embodiment, the further controller workstation CWP2 of the further controller, which is shown in FIG. 2, is equipped in the same way as the first controller workstation CWP1, i.e. it has another loudspeaker, another microphone, another input unit, another control and processing unit with another buffer memory, another push-to-talk unit, etc.

In order to carry out their mission, in a previous planning phase the two air traffic controllers were assigned the coverage frequencies or radio channels V-01, U-02, U-03 and U-04 to use, via which four different radio station groups CG can be reached. While radio channel V-01 is operated in the civilian part of the VHF band, radio channels U-02, U-03 and U-04 are radio channels of radio station groups CG in the military part of the UHF band. All radio station groups CG in the exemplary embodiment consist of three radios each, which are located at three different radio sites. These radio sites are distributed over the area of operations in such a way that each point can be reached from at least one of the three sites (see FIG. 2).

All radios within a radio station group CG receive and transmit on the same radio frequency or channel. Each of the air traffic controllers has the opportunity to select one or more of the radios of a radio station group CG for reception. If several radios of the same radio station group CG are selected for reception, a voice communication system VCS according to the invention offers the possibility to automatically switch the audio signal of the radio which currently has the best signal quality of the received signal to the controller. All aircraft that are to be reached on a radio station group CG also have their radio set to the respective frequency.

The civil radio station group CG with the radio channel V-01 is known to both civil and military air traffic and is used for coordination. It can be assumed that all aircraft in the area of operations can be reached on this radio frequency.

The radio station groups CG with the radio channels U-02, U-03 and U-04 were communicated to their own pilots during the mission briefing and are used to pass on mission-relevant information that is potentially subject to secrecy. In order to ensure the confidentiality of the information exchanged via this, an encrypted communication mode S is used with an encryption method that is implemented by key devices.

The key devices convert an outgoing voice signal into an encrypted voice signal, which can only be decrypted by the receiver using a similar key device with an identical key, before it is actually transmitted by the radio. For recipients who do not have the appropriate key device and key, an intercepted transmission remains incomprehensible.

Such a key device is present on each of the radios of the radio station groups CG with the radio channels U-02, U-03 and U-04 on the ground, as well as on board military aircraft. In advance, keys were generated for the radio channels U-02 and U-04 and loaded into the key devices both on the ground and in the aircraft.

The radio station group CG with the radio channel U-03 has key devices, but is operated unencrypted for the described current mission, i.e. in the unencrypted communication mode P. While the radio channels U-02 and U-03 are only used by their own aircraft, the radio station group CG with the radio channel U-04 is also known to military aircraft from a friendly neighboring country and can be used for coordination with them.

The following configuration of the radio station groups CG is therefore obtained:

| | | | | | Push-to- |
|---|---|---|---|---|---|
| Radio | Frequency | | Encryption | Encryption | Talk |
| channel | band | Use | possible | active | button |
| V-01 | VHF | Civil | No | No | PTT1 |
| U-02 | UHF | Military | Yes | Yes | PTT2 |
| | | National | | | |
| U-03 | UHF | Military | Yes | No | PTT1 |
| | | National | | | |
| U-04 | UHF | Military | Yes | Yes | PTT2 |
| | | international | | | |

### Preparation

In preparation for the mission, both air traffic controllers assign the radio station groups CG with the radio channels V-01 and U-03, which are in transmit/receive mode TX, to the push-to-talk button PTT1. This means that the two unencrypted radio station groups CG, i.e. the radio station groups CG that are in the unencrypted communication mode P, can be operated together and the air traffic controllers can send the same radio message in both the VHF band and the UHF band at the same time.

The encrypted radio station groups CG with the radio channels U-02 and U-04, i.e. the radio station groups CG that are in encrypted communication mode S and in transmit/receive mode TX, are configured by both air traffic controllers on the push-to-talk button PTT2.

When the controller associates or assigns several radio station groups CG with or to the same Push-to-talk button PTT1, PTT2, the control and processing unit in the exemplary embodiment checks whether the same communication mode is assigned to each of the individual radio station groups CG. In this way, it is reliably avoided that an unintentional transmission of confidential speech can take place on an unencrypted radio channel or to one or more radio station groups in the unencrypted communication mode P.

In the exemplary embodiment, both controllers can now hear the radio traffic on all four radio station groups CG at the same time without further operating steps on the touchscreen of the voice communication system VCS by selecting the assignment of the radio station groups CG to the push-to-talk buttons PTT1, PTT2. Furthermore, they can transmit simultaneously on the two unencrypted radio station groups CG with the radio channels V-01 and U-03 by pressing the push-to-talk button PTT1, or on the encrypted radio station groups CG with the radio channels U-02 and U-04 by pressing the push-to-talk button PTT2.

Thus, messages spoken into the microphone 5 by the respective controller are only transferred to those radio station groups CG that are assigned to the push-to-talk button that has just been pressed for sending.

### Procedure

During the mission, a first of the two controllers perceives problems in communication with one of the aircraft of the friendly neighboring state via the radio station group CG with the radio channel U-04. Since he attributes these problems to the encryption, he switches the radio station group CG with the radio channel U-04 from the encrypted communication mode S to the unencrypted communication mode P. Technically, this switchover is communicated from the first controller workstation CWP1 to all three radios of the relevant radio station group CG that are involved in the radio channel U-04.

Each of these radios switches to unencrypted communication or to the unencrypted communication mode P and shares this information with all other components of the voice communication system VCS to which it is connected. In the exemplary embodiment, this applies in particular to the further controller workstation CWP2, which is located in another building and is therefore not yet aware of the communication problems and the resulting switch to the unencrypted communication mode P.

The software, which is stored on the control and processing unit on the further controller workstation CWP2, recognizes that switching radio channel U-04 to the unencrypted communication mode P has resulted in an inadmissible combination of encrypted and unencrypted radio station groups CG on the Push-to-talk button PTT2.

In order to prevent the unintentional transmission of confidential speech on radio channel U-04, in the exemplary embodiment the control and processing unit of the controller workstation CWP2 automatically removes the radio station groups CG with radio channel U-04 from the push-to-talk button PTT2 and informs the controller of this fact by means of a warning tone emitted in the headset and a visual error message on the touchscreen or the input unit 1.

The state of the radio station groups CG has thus changed as follows:

| | | | | | Push- |
|---|---|---|---|---|---|
| Radio | Frequency | | Encryption | Encryption | to-talk |
| channel | band | Use | possible | active | button |
| V-01 | VHF | Civil | No | No | PTT1 |
| U-02 | UHF | Military | Yes | Yes | PTT2 |
| | | National | | | |
| U-03 | UHF | Military | Yes | No | PTT1 |
| | | National | | | |
| U-04 | UHF | Military | Yes | No | none |
| | | international | | | |

This design of a voice communication system according to the invention with a check for inadmissible combinations of radio station groups CG in encrypted communication mode S and in unencrypted communication mode P on the same push-to-talk button ensures a reliable separation of radio transmissions into security areas and the controllers are informed of any changes in the security settings of the currently used radio channels.

The further handling of the error can now be carried out manually by the controllers, for example by one of the following measures:

Assignment of the now unencrypted radio station group CG with the radio channel U-04 to the push-to-talk button PTT1, whereby the three unencrypted radio station groups CG with the radio channels V-01, U-03 and U-04 are operated via the same push-to-talk button.

If no transmission to radio channel U-04 is necessary, the radio channel U-04 can be switched to pure reception operation, for which no assignment to a push-to-talk button is required.

Switching the radio channel U-02 to unencrypted communication or the unencrypted communication mode P and reassignment of the radio station group CG with the radio channel U-04 to the push-to-talk button PTT2.

While the encryption mode or encrypted communication mode S or the unencrypted communication mode P of a frequency or of a radio channel of a radio station group CG is the same for all controllers, the assignment to a push-to-talk button can be made separately by each controller and without affecting other controllers.

This is operationally relevant and advantageous in order to enable flexible use of the radio station groups CG by the controllers. In the exemplary embodiment, the consistency rules or consistency check of the control and processing unit of the controller workstations CWP1, CWP2 in a voice communication system VCS according to the invention prevents an assignment of encrypted and unencrypted radio station groups CG to the same push-to-talk button.

If only encrypted or only unencrypted radio station groups CG are used, the system also allows the radio station groups CG to be allocated to the two push-to-talk buttons as desired. Since the assignment of the radio station groups CG to push-to-talk buttons takes place on the respective controller workstation CWP1, CWP2 and thus no communication with other system components is necessary, the mechanism advantageously works practically without delay and without affecting any other participants in the system.

The control and processing unit of the respective controller workstation CWP1, CWP2 can optionally also carry out further consistency checks in order to avoid confidential voice radio messages being transmitted to radio station groups CG in the unencrypted communication mode P.

For example, when using a radio station group CG for the first time on a further controller workstation CWP2, the control and processing unit can determine the current communication mode of the radio station group CG and display it to the user. This ensures that the newly added user at the controller workstation CWP2 is informed about the current status of all radio station groups before making any changes to the communication mode.

Furthermore, after assigning several radio station groups CG to a respective push-to-talk button, the control and processing unit of the respective controller workstation CWP1, CWP2 can optionally check at specified intervals whether the same communication mode is still assigned to the individual radio station groups CG, or whether the communication mode of individual radio station groups CG has changed. In this case, the control and processing unit terminates the assignment of the radio station group in question to the respective push-to-talk button in order to prevent confidential radio messages from being sent in the unencrypted communication mode P.

In general, when detecting such conflicts or inadmissible combinations of radio station groups CG in encrypted and unencrypted communication mode on the same push-to-talk button by the control and processing unit, there is the possibility that—as in the exemplary embodiment—a visual and/or audible warning message is issued to the controller at their controller workstation CWP1, CWP2, for example. These can be warning tones, light signals, graphical user interfaces with a warning message that are displayed on the input unit, or the like.

Such warnings may be issued, for example, if:
when assigning several radio station groups CG to a respective push-to-talk button, one of the radio station groups CG is not assigned the same communication mode,
the assignment of a radio station group to the push-to-talk button is terminated by the control and processing unit,
the communication mode of one of the radio station groups CG used at the controller workstation in question is changed by the user of another, different controller workstation.

In general, the push-to-talk unit 7 according to the invention can of course also have more than two push-to-talk buttons. In this way, the controllers can communicate even more flexibly and efficiently with different radio station groups CG and, for example, assign two push-to-talk buttons to radio station groups CG in encrypted communication mode S. This ensures, for example, that the transmission of confidential radio messages can be carried out to different radio station groups CG in encrypted communication mode S, depending on the content selected depending on the selected push-to-talk button.

Although the previously described exemplary embodiment of a voice communication system according to the invention has been explained in the context of aviation, a voice communication system according to the invention can also be used in other application fields in which several radio channels have to be operated in rapid succession, such as in connection with public safety, in particular where dispatchers of an emergency control center need to communicate with emergency services spread over a wider geographical area via radio. The dispatchers (who correspond to the air traffic controllers in the example above) work in emergency control centers at working positions that are similar to the controller workstations CWP1, CWP2 of the example above.

1. A voice communication system, comprising:
a plurality of transmitting/receiving systems for transmitting and/or receiving radio signals to a radio station group and/or from a plurality of radio station groups, wherein the radio station groups each contain a plurality of geographically distributed radio stations and wherein voice radio messages are sent to individual ones of the radio station groups on different radio channels and/or received by the individual radio station groups;
a first common controller workstation connected to said transmitting/receiving systems, said first common controller workstation having a loudspeaker for outputting the voice radio messages to a user, a microphone for receiving the voice radio messages emitted by the user and an input unit, wherein a receive transmission mode or a transmit/receive transmission mode is selected for the individual radio station groups by the user via said input unit, and wherein an encrypted communication mode or an unencrypted communication mode is selected for the individual radio station groups by the user via said input unit;
said first common controller workstation contains a push-to-talk unit;
said first common controller workstation contains a control and processing unit, wherein said control and processing unit contains a buffer memory and wherein the radio channels of the individual radio station groups as well as a respective selected transmission mode are stored in said buffer memory; and
said push-to-talk unit contains at least two configurable push-to-talk buttons, wherein each of said configurable push-to-talk buttons is assigned at least one of the radio station groups and one communication mode by the user via said input unit.

2. The voice communication system according to claim 1, further comprising at least one second common controller workstation connected to said transmitting/receiving systems.

3. The voice communication system according to claim 2, wherein said at least one second common controller workstation contains a further loudspeaker for the output of the voice radio messages to the user, a further microphone for receiving the voice radio messages emitted by the user, a further input unit, and a further control and processing unit with a further buffer memory, wherein:
the receive transmission mode or the transmit/receive transmission mode is selected for the individual radio station groups by the user via said further input unit;
the encrypted communication mode or the unencrypted communication mode is selected for the individual radio station groups by the user via said further input unit;
wherein the radio channels of the individual radio station groups as well as a respective selected transmission mode are stored in said further buffer memory; and
wherein said at least one second common controller workstation contains a further push-to-talk unit, wherein said further push-to-talk unit contains at least two configurable push-to-talk buttons, wherein at least one of the radio station groups and the one communication mode can be assigned to each of said configurable push-to-talk buttons by the user via said further input unit.

4. The voice communication system according to claim 1, wherein said control and processing unit is configured to check whether a same communication mode is assigned to the individual radio station groups when the user assigns several of the radio station groups to a respective one of said configurable push-to-talk buttons.

5. The voice communication system according to claim 2, wherein said control and processing unit is configured to determine the current communication mode of the radio station group concerned when said at least one second common controller workstation is connected when a respective radio station group is used for a first time at said at least one second common controller workstation.

6. The voice communication system according to claim 1, wherein said control and processing unit is configured to check at specified intervals after an assignment of several said radio station groups to a respective one of said configurable push-to-talk buttons whether a same communication mode is still assigned to the individual radio station groups and, in an event of detecting a change in the communication mode of the radio station group to terminate an assignment of the radio station group in question to said respective push-to-talk button.

7. The voice communication system according to claim 2 wherein said control and processing unit is configured to output a warning to the user at said first common controller workstation, wherein:
in an event that when several said radio station groups are assigned by the user to a respective one of said configurable push-to-talk buttons, one of the radio station groups is not assigned a same communication mode; and/or
in an event that an assignment of the radio station group to one of said configurable push-to-talk buttons has ended; and/or
in an event of a change in the communication mode of one of the radio station groups by the user of said at least one second common controller workstation.

8. The voice communication system according to claim 1, wherein said first common controller workstation has a head set, said loudspeaker and/or said microphone and/or said push-to-talk unit are disposed in and/or on said headset.

9. The voice communication system according to claim 1, wherein at least one said radio station group for which the transmit/receive transmission mode is selected is assigned by the user via said input unit to each of said configurable push-to-talk buttons.

10. The voice communication system according to claim 5, wherein said control and processing unit is configured to display a current communication mode of the radio station group in question to the user at said second common controller workstation.

11. The voice communication system according to claim 1, wherein said control and processing unit is configured to check continuously after an assignment of several said radio station groups to a respective one of said configurable push-to-talk buttons whether a same communication mode is still assigned to the individual radio station groups and, in an event of detecting a change in the communication mode of the radio station group to terminate an assignment of the radio station group in question to said respective push-to-talk button.

12. The voice communication system according to claim 7, wherein the warning is a visual and/or acoustic warning.
